(19) United States
(12) Patent Application Publication
(10) Pub. No.: US 2008/0037039 A1
(43) Pub. Date: Feb. 14, 2008

(54) Scanning Module

(75) Inventors: Kuo-Kuang Wu, Hsinchu (TW); Shih-Chung Liu, Hsinchu (TW); Chieh-Hao Hsu, Hsinchu (TW); Chih-Kang Hsu, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: FOXLINK IMAGE TECHNOLOGY CO., LTD., Hsinchu (TW)

(21) Appl. No.: 11/463,969

(22) Filed: Aug. 11, 2006

(51) Int. Cl. H04N 1/00

(52) U.S. Cl. 358/1.6

(57) ABSTRACT

A scanning module includes a contact image sensor for scanning a document, an elastic unit having a fixing board placed in the middle of the elastic unit, two flexible spring arms, and a base mounted on the fixing board of the elastic unit. The elastic unit is placed between the contact image sensor and the base. Each of the flexible spring arms is bending upwardly and extending outwardly from the left and the right sides of the fixing board. The contacting piece is bending upwardly and extending outwardly from the end of each flexible spring arms and contacts the bottom surface of the contact image sensor.

### BACKGROUND OF THE INVENTION

1. Field of the Invention

The present invention relates to a scanning module, and more particularly to a scanning module having an elastic unit.

2. The Related Art

Scanning modules are disposed for applications such as fax machines, scanners, copiers and measuring equipment. FIG. 6 shows a traditional scanning module 2 having a contact image sensor 40, a spring 50, a carrying base 60 and a driven base 70.

The contact image sensor 40 has a top surface 41 attaching to an underside of a glass window and a bottom surface 44 connecting to the carrying base 60. The carrying base 60moves along the driven base 70 in order that the contact image sensor 40 scans the document and receives images during the movement of the scanning module 2.

Fixing poles 43 and 45 are disposed on the two side of the contact image sensor 40. The spring 50 is compressed between the contact image sensor 40 and the carrying base 60 to supply the suitable force to the contact image sensor 40. The carrying base 60 is substantially in a rectangle shape. The front side and the rear side of the carrying base 60 bend up and form the sidewall 62. The left side and the right side of the carrying base 60 bend up and form a sleeve 63 and a sleeve 65 of which defines a hole in the middle. The middle of the carrying base 60 has a plurality of fixing hole 611 and two protrusions 610 to fix the spring 50. The driven base 70 has a fixing plane 71 and a plurality of pillars 72 protrude thereof corresponding to the plurality of fixing hole 611 to firmly mate with the carrying base 60.

When assembling, the pillars 72 are inserted into the fixing holes 611 to fasten the carrying base 60 with the driven base 70. The spring 50 compressed between the contact image sensor 40 and the carrying base 60 is for pressing the contact image sensor 40 so as to make the sleeves 63 and 65 firmly engaging with the fixing poles 43 and 45.

Conventionally, the scanning module sustains a certain tolerance. An interval is existed more or less and constantly become wider in terms of the scanning module 2 disposed rapidly. Therefore, when the sleeves 63 and 65 of the carrying base 11 deform slightly, an unbalanced force is generated and pushes the carrying base 11 to contact the glass window 18 unsteadily. This increases a friction between the contact image sensor 40 and the carrying base 60 and therefore generates the vibration and noise. Further, the contact image sensor 40 cannot be fixed and results in poor scanning quality.

### SUMMARY OF THE INVENTION

An objective of the present invention is to provide a scanning module that makes the scanning module smoothly sliding over a glass window and acquiring the good scanning quality.

In order to fulfill the above objective, the present invention provides a scanning module comprising a contact image sensor for scanning a document placed on a glass windows of a scanner, and having a top surface and a bottom surface, an elastic unit having a fixing board placed in the middle of the elastic unit and two flexible spring arms, and a base mounted to the fixing board of the elastic unit so that the elastic unit is placed between the contact image sensor and the base. Wherein each of the flexible spring arms is bending upwardly and extending outwardly from the left and the right sides of the fixing board, a contacting piece is bending upwardly and extending outwardly from the end of each flexible spring arm and contacts the bottom surface of the contact image sensor.

The elastic unit has a fixing board placed in the middle of the elastic unit and two flexible spring arms. The flexible spring arm firmly contacts the bottom surface of the contact image sensor through the contacting piece. Therefore, the contact image sensor contacts the elastic unit steadily. It will avoid irregular vibrating which resulting in poor scanning quality when scanning.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a first embodiment of a scanning module according to the present invention;

FIG. 2 is a top plan view of an elastic unit of the scanning module;

FIG. 3 is a front elevational view of the elastic unit in FIG. 2;

FIG. 4 is a perspective view of a second embodiment of the elastic unit of the scanning module;

FIG. 5 is a front elevational view of the elastic unit in FIG. 4; and

FIG. 6 is an exploded view of a conventional scanning module.

### DETAILED DESCRIPTION OF THE PREFERRED EMBODIMENTS

For facilitating understanding, like components are designated by like reference numerals throughout the various embodiments of the invention as shown in the attached drawings.

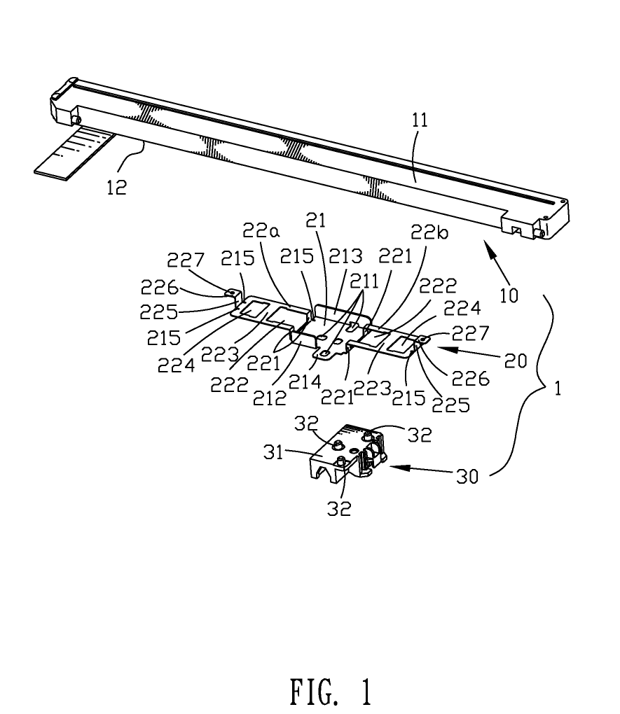

First referring to FIG. 1, a first embodiment of a scanning module according to the present invention includes a contact image sensor 10, an elastic unit 20, and a base 30. The contact image sensor 10 is disposed to scan a document placed a glass windows of a scanner. The base 30 is mounted to the fixing board 21 of the elastic unit 20 so that the elastic unit 20 is placed between the contact image sensor 10 and the base 30.

The contact image sensor 10 has a top surface 11 and a bottom surface 12. The contact image sensor 10 moves along a guide rod (not shown) and contacts an underside of a glass window so as to scan a document.

The elastic unit 20 has a fixing board 21 placed in the middle of the elastic unit 20 and two flexible spring arms 22a and 22b. Two flexible spring arms 22a and 22b are located at two opposite sides of the base 31. The fixing board 21 is in rectangular shape and a plurality of mating holes 211 is defined in it. The front side and the rear side of the fixing board vertically bend up and respectively form a first side 212 and a second side 213. The right side of the fixing board 21 extends forward and forms a rectangular slice 214. Two flexible spring arms 22a and 22b are vertically and upwardly bended from the left and right sides of the fixing board 21 respectively, and then, extending horizontally and outwardly from opposite sides thereof. A contacting piece 226 is substantially in a rectangular shape and a fixing hole 227 is defined in it. The contacting piece 226 is bending vertically and upwardly from the flexible spring arms 22a, 22b, and then extending horizontally and outwardly respectively. The contacting piece 226 contacts the bottom surface 12 of the contact image sensor 10, the flexible spring arms 22a, 22b and the contacting piece 226 form a stair shaped structure. Two rectangular holes 222 and 227 are defined side by side in the middle of flexible spring arms 22a and 22b. In order to get balance, the elastic unit 20 is preferably supported at the center of weight of the contact image sensor 10. Each of the flexible springs arms 22a and 22b is equivalent and symmetrical to the fixing board 21.

Further, The contact image sensor 10 can be connected to the elastic unit 20 by a bolt (not shown) through the fixing hole 227 or by another way of engagement. The contacting piece 226 can also be adhered with a thermal adhesive and firmly attached to the bottom surface 12 of the contact image sensor 10.

The base 30 has a mounting surface 31 and a plurality of cylinder poles 32 upwardly protrudes thereof corresponding to the plurality of mating holes 211 to firmly mount on the fixing board 21. By this arrangement, the base 30 firmly contacts to the elastic unit 20 and provides enough force to the fixing board 21.

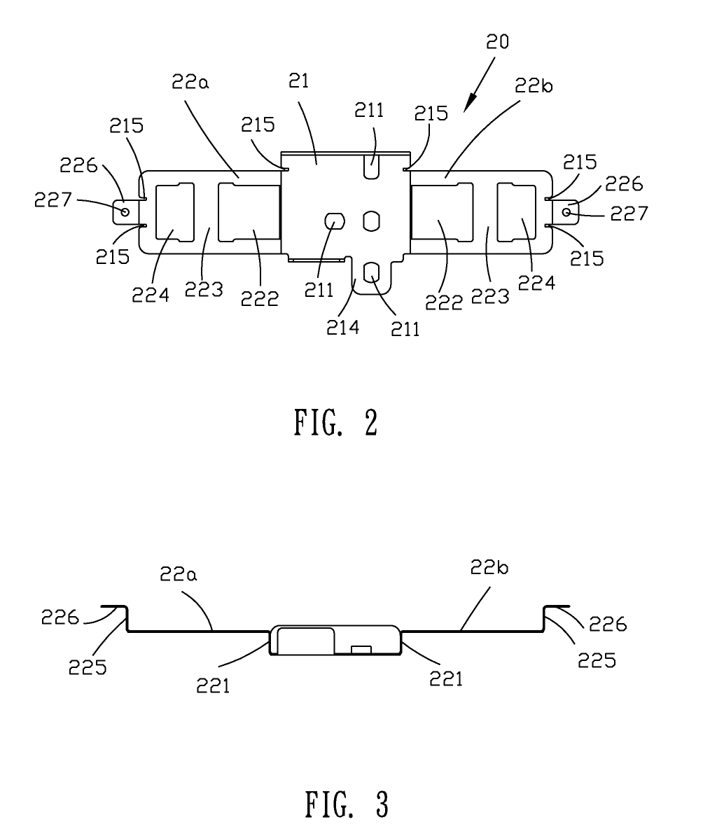

With reference to FIGS. 2 and 3, the left and right sides of the fixing board 21 forms a channel 215 which being defined along the flexible spring arms 22a, 22b to supply the suitable flexibility force onto the elastic unit 20. The fixing board 21 of the elastic unit 20 is defined with plural mating holes 211. The fixing board 21 is parallel to the up surface of the contacting piece 226.

When the contact image sensor 10 is placed between the elastic unit 20 and the glass window (not shown), the contact image sensor 10 will urge the elastic unit 20. The contact image sensor 10 connects to the elastic unit 20 by bolts or by the thermal adhesive attached to the contacting piece 226 so as to make the contact image sensor 10 firmly contacting the elastic unit 20 and avoiding irregular vibration which resulting in poor scanning quality when scanning.

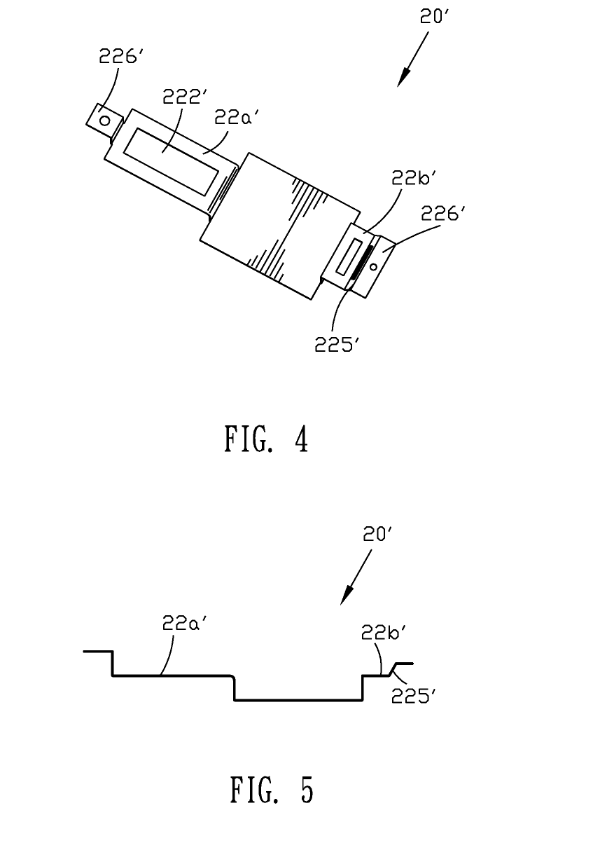

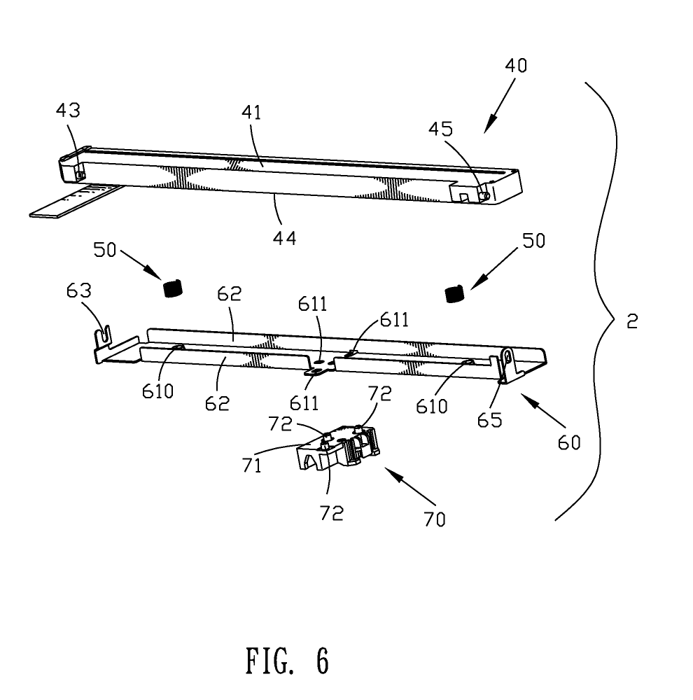

FIGS. 4 and 5 show another embodiment of the elastic unit 20′ in the present invention. Each of the flexible spring arms 22a′, 22b′ is extended from two side of the elastic unit 20′. The flexible spring arms 22a′ and 22b′ are not equivalent. A rectangular hole 222 is defined in the middle of the flexible spring arm 22a′. The end of the flexible spring arm 22b′ bends up by an angle less than 90 degree and forms a bending board 225′. The flexible spring arm 22a′ is longer than the flexible spring arm 22b′. Two contacting piece 226′ extends horizontally and outwardly respectively from the opposite of the flexible spring arms 22a′, 22b′. The flexible spring arms 22a′ and 22b′ support a suitable force to the elastic unit 20.

It is to be noted that the elastic unit 20 and 20′ have flexible spring arms 22a, 22b, 22a′, 22b′ which form a contacting piece 226 and 226′ respectively. The contact image sensor 10 connects to the elastic unit 20 or 20′ by bolts or by the thermal adhesive attached to the contacting piece 226 so as to make the contact image sensor 10 firmly contacting the elastic unit 20 and avoiding irregular vibration and noise when scanning.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A scanning module, comprising:
a contact image sensor for scanning a document placed on a glass windows of a scanner, and having a top surface and a bottom surface;
an elastic unit having a fixing board placed in the middle of the elastic unit and two flexible spring arms; and
a base mounted to the fixing board of the elastic unit so that the elastic unit is placed between the contact image sensor and the base;
wherein each of the flexible spring arms is bending upwardly and extending outwardly from the left and the right sides of the fixing board, a contacting piece is bending upwardly and extending outwardly from the end of each flexible spring arm and contacts the bottom surface of the contact image sensor.

2. The scanning module as claimed in claim 1, wherein the contacting piece is in a rectangular shape wherein a fixing hole is defined in the contacting piece.

3. The scanning module as claimed in claim 1, wherein the contacting piece is adhered with a thermal adhesive and firmly attached to the bottom surface of the contact image sensor.

4. The scanning module as claimed in claim 1, wherein the fixing board of the elastic unit is defined with the plurality of mating holes, and the base upwardly protrudes a plurality of cylinder poles corresponding to the mating holes in order to mount on the fixing board.

5. The scanning module as claimed in claim 1, wherein the fixing board is parallel to the contacting piece.

6. The scanning module as claimed in claim 1, wherein the flexible spring arm bends vertically and upwardly, and then, extends horizontally and outwardly from opposite sides thereof, and the contacting piece bends vertically and upwardly, and then, extends horizontally and outwardly from the flexible spring arm and contacts the bottom surface of the contact image sensor, the flexible spring arm and the contacting piece therefore form a stair shaped structure.

7. The scanning module as claimed in claim 1, wherein the left and right sides of the fixing board form a channel which is defined along the flexible spring arm to supply a force onto the flexible spring arm.

8. The scanning module as claimed in claim 1, wherein two rectangular holes are defined side by side in the middle of the flexible spring arm.

9. The scanning module as claimed in claim 1, wherein the flexible spring arm is symmetrical to the fixing board.
